(19) United States
(12) Patent Application Publication
(10) Pub. No.: US 2008/0310039 A1
(43) Pub. Date: Dec. 18, 2008

(54) LENS SYSTEM

(75) Inventor: Isao Tanaka, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/136,849

(22) Filed: Jun. 11, 2008

(30) Foreign Application Priority Data
Jun. 15, 2007 (JP) 2007-158336

(51) Int. Cl. G02B 7/02

(52) U.S. Cl. 359/823

(57) ABSTRACT

A lens system includes a first lens apparatus having a first movable optical member and a first set command unit that changes a drive control parameter for the first movable optical member by performing wireless communication with the first lens apparatus.

### BACKGROUND OF THE INVENTION

1. Field of the Invention

The present invention relates to a lens apparatus having a movable optical member such as a zooming lens and a lens system including such a lens apparatus.

2. Description of the Related Art

U.S. Pat. No. 7,268,818 and European Publication No. 0 991 269 disclose a control system for a movable optical member such as a zooming lens and focusing lens in a television camera lens. U.S. Pat. No. 7,268,818 discloses a lens apparatus in which various settings for a lens body can be performed using a display unit and a command unit having four-directional switches (or keys) provided on the lens body.

The settings for the lens body include control drive characteristics of movable optical members such as a zooming lens, a focusing lens and a stop. Specifically, the settings may include, for example, setting of the maximum speed, setting of drive response, setting of drive resolution, setting of a dead band to a command entry and setting of transformation of command input. In addition, allocation of functions to the switches provided on the lens body can also be included. U.S. Pat. No. 7,268,818 also discloses a lens apparatus that can be connected with another lens apparatus by a specific cable for exclusive use to enable the settings to be copied from one apparatus to the other.

European Publication No. 0 991 269 discloses a lens apparatus to which an external device such as a computer is connected by a specific cable for exclusive use to enable control drive characteristics of a movable optical member to be changed.

Such setting changes may be performed according to shooting situations such as sport casting, drama shooting and news casting or preferences of camera operators, whereby a lens apparatus can have good operationality and performance.

In the above described prior arts, when setting of drive control or a switch function of a lens apparatus is to be performed, the setting needs to be performed manually for each lens apparatus. Especially in cases where there is a plurality of lens apparatuses in a studio, it is necessary to change the setting of all the lens apparatuses in the studio one by one according to the shooting situation or a change of the camera operator in charge of shooting. This takes time and effort. In addition, since the setting is performed manually on an apparatus by apparatus basis, there is a risk that a mistake in setting may occur. Furthermore, since a specific cable for exclusive use is needed, preparation for setting can sometimes take time.

### SUMMARY OF THE INVENTION

A lens system according to the present invention that is intended to achieve the above described object is characterized by comprising a first lens apparatus including a first movable optical member and a first set command unit that changes a drive control parameter of the first movable optical member by performing wireless communication with the first lens apparatus.

Further features of the present invention will become apparent from the following description of exemplary embodiments with reference to the attached drawings.

### BRIEF DESCRIPTION OF THE DRAWINGS

FIG. 1 is a circuit block diagram of an embodiment.

FIG. 2 is a flow chart of a process in a computer.

FIG. 3 is a flow chart of a process executed in a lens body.

FIG. 4 is a flow chart of a process of driving a zooming lens.

### DESCRIPTION OF THE EMBODIMENT

A preferred embodiment of the present invention will now be described in detail with reference to the accompanying drawings.

An exemplary object of the embodiment described in the following is to provide a lens system and lens apparatuses in which change of setting for a plurality of lens apparatuses can be performed reliably through wireless communication, in response to a change in the shooting situation or the operator in charge of shooting.

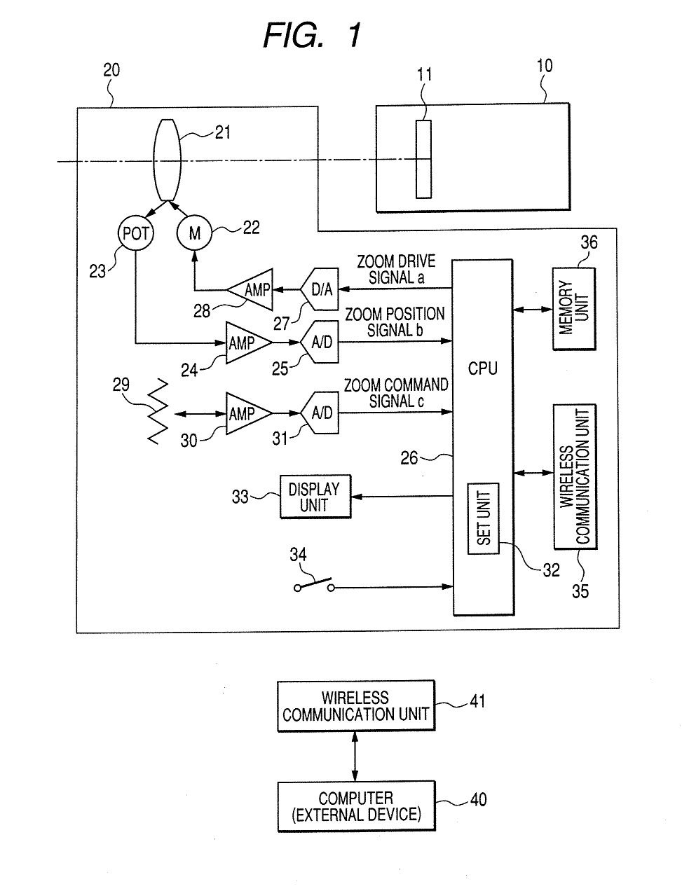

FIG. 1 is a circuit block diagram of the embodiment. The lens system according to the embodiment includes a camera body 10, a lens body 20 as a lens apparatus that can be detachably mounted on the camera body 10 and a computer 40 as an external device. The lens system has a set command unit (which will be designated by reference sign 34 later) that is integral with (fixed to) the camera body 10 or the lens body 20, or connected with them by wire. Furthermore, the lens system according to this embodiment has another set command unit that is wirelessly connected with the lens body 20, which unit is characteristic to this system. Although this additional set command unit is, in this embodiment, the aforementioned computer 40, the additional set command unit may be provided in another lens apparatus or only the additional set command unit may be provided separately from the lens apparatus. The additional set command unit may have a wireless communication unit 41, which will be described later, as a built-in unit.

The camera body 10 has an image pickup element (photoelectric transducer) 11 such as a CCD. The lens body 20 removable from the camera body 10 has a zooming lens 21 as a movable optical member. The lens body 20 also has a focusing lens (unit), a stop, an extender (lens unit) and an optical image stabilization lens (lens unit) arranged along the optical axis of the zooming lens, which components are not shown in the drawings. Although in this embodiment description will be directed mainly to the zooming lens 21, the present embodiment may be applied to the focusing lens, the stop, the extender or the optical image stabilization lens, or some of these movable optical members.

For the zooming lens 21 are provided a zoom motor 22 that drives the zooming lens 21 and a potentiometer 23 that detects the position of the zooming lens 21. The output of the potentiometer 23 is connected to a CPU 26 via an amplifier 24 and an A/D converter 25, and the output of the CPU 26 is connected to the zoom motor 22 via a D/A converter 27 and an amplifier 28.

The CPU 26 is further connected with the output of a potentiometer 29 that detects the operation amount of a zoom ring that is operated by an operator to drive the zooming lens 21, via an amplifier 30 and an A/D converter 31. Furthermore, the CPU 26 has a built-in set unit 32 (namely, the CPU 26 has a setting function, or a function of setting drive control parameters). The CPU 26 is connected with a display unit 33 such as a liquid crystal display, a set command unit 34 and a wireless communication unit 35. The CPU 26 is also connected with a memory circuit (a memory unit) 36 in which identification data specific to the lens is stored. The set unit 32 is provided in the CPU 26, and it may be a function implemented in the CPU 26, though it may be provided as a circuit independent from the CPU 26. In other words, the CPU 26 and the set unit 32 may refer to the same calculation circuit.

The computer 40 is a common one, which is provided with a main body, a keyboard, a mouse and a display etc. A wireless communication unit 41 that enables wireless communication with the wireless communication unit 35 of the lens body 20 is connected to the computer 40. With the computer (another set command unit) 40, changing of a drive control parameter(s) for the zooming lens can be commanded by operating the keyboard or mouse, touching the display or using other specific interface. The command (command signal) for changing the drive control parameter(s) is transmitted wirelessly to the lens body 20. The CPU 26 receives the command for changing the parameter(s) and change the setting of the drive control parameter(s).

The D/A converter 27 in the lens body 20 converts a zooming lens drive signal a in the form of a digital value supplied from the CPU 26 into an analogue value. The amplifier 28 electrically amplifies this analogue drive signal a to drive the zoom motor 22 thereby actuating the zooming lens 21.

The signal from the potentiometer 23 is amplified by the amplifier 24, and the analogue voltage is converted by the A/D converter 25 into a digital value, which is read by the CPU 26 as a zooming lens position signal b. As the position detection unit, an encoder may be used in some cases in place of the potentiometer 23.

The potentiometer 29 outputs a signal indicative of an operation amount of the zoom ring operated by an operator such as a camera operator. The amplifier 30 amplifies this signal. This zooming lens command signal c is converted into a digital signal by the A/D converter 31 and output to the CPU 26.

The display unit 33 and the set command unit (a unit that allows an operator to enter a command for setting a drive control parameter(s) of the zooming lens using a switch or the like) 34 are used to change the setting of the drive control parameter(s) through the lens body 20 alone. The wireless communication unit 35 in the lens body 20 communicates wirelessly with the wireless communication unit 41 connected to the computer 40 in order to change various settings (or set control parameters) for the zooming lens 21. A standardized communication scheme such as wireless LAN, Bluetooth or Zigbee may be used in this wireless communication.

With the above described features, when the operator manipulates the zoom ring, the potentiometer 29 linked with the zoom ring sends a digitized zooming lens command signal c to the CPU 26 through the amplifier 30 and the A/D converter 31. The CPU 26 outputs a zooming lens drive signal a in accordance with a process illustrated in a process flow chart that will be described later, whereby the zoom motor 22 is driven and the zooming lens 21 is moved.

The CPU 26 controls the lens body 20, and the set unit 32 changes the setting of a drive control parameter(s) based on a set command entered through the computer 40 or the set command unit 34 (the set command may be entered using the display unit 33).

Although in the embodiment shown in FIG. 1, one lens body 20 and one computer 40 are connected by wireless communication, there may be a plurality of lens bodies 20. In the case where there is a plurality of lens bodies 20, the computer 40 identifies and manages each of the lens bodies 20 based on specific identification data that each of the lens bodies 20 has, and executes commands for reading and rewriting various set values for each of the lens bodies 20. As the specific identification data, the product name, serial number and version number stored in the memory unit 36 may be used. Alternatively, information (such as a number or sign) arbitrary set for each lens body 20 may be used.

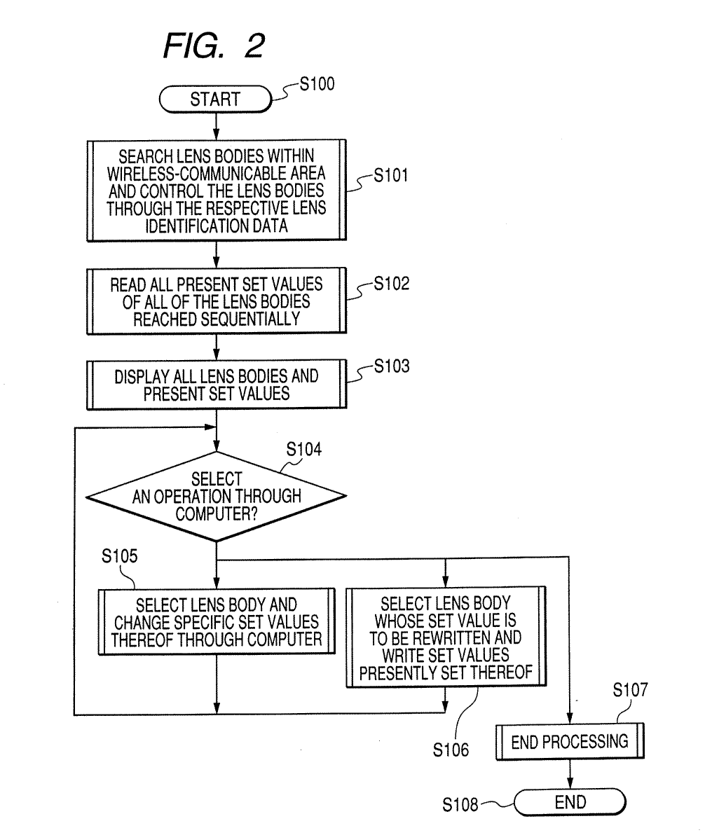

FIG. 2 is a flow chart of a process executed in the computer 40. The process starts in step S100, and then proceeds to step S101, where all the lens bodies 20 existing in the wirelessly-communicable area (e.g. in a studio) are searched for, and the lens bodies 20 thus reached are controlled using the lens identification data specific to the respective lens bodies 20.

When the computer 40 designates a specific lens body 20, it sends identification data (ID). The identification data used at this time is the specific lens identification data. In the target lens search routine in step S101, the computer 40 first transmits a search command to a plurality of unspecified lens bodies 20. When lens bodies 20 receive the search command, they transmit specific lens identification data stored in their respective memory units 36.

Subsequently, when the computer 40 receives the respective specific lens identification data, the computer 40 transmits, in replay thereto, a communication establishment command together with identification data (ID) to each lens body 20 from which the data has been received to notify it of establishment of communication.

Thus, the process of the target lens search routine is completed, and the process proceeds to step S102. The process of step S102 is a set value read routine in which set values are read sequentially from the target lens bodies 20. In this process, a setting read command is sent together with identification data (ID) from the computer 40 to each of the lens bodies 20 with which communication has been established by the process in step S101. Each lens body 20 transmits a set value as commanded, if the identification data (ID) received by it is identical to its own.

After that, the computer 40 reads the set value transmitted from the lens body 20. The computer 40 executes the above described sequential process for all the lens bodies 20 with which communication has been established. Then, the set value read routine in step S102 is terminated, and the process proceeds to step S103.

The process of step S103 is a set value display routine in which the set values of the respective lens bodies 20 read in step S102 are displayed as a list on the display unit 33. After completion of the display, the process proceeds to step S104. In step S104, what operation is to be performed on the content displayed on the display unit 33 is selected using the keyboard or mouse of the computer 40. If an entry for changing the set content is to be made, the process proceeds to step S105. If the displayed set content is written (overwritten) back into each lens body 20, the process proceeds to step S106. If the process is to be terminated, the process proceeds to step S107.

The process of step S105 is a set value change routine in which displayed set values are changed into desired values through the computer 40. After completion of changing, the process returns to step S104.

The process of step S106 is a set value write-back routine in which displayed or selected set values are written back into the lens body 20. In the set value write-back routine, a target lens body 20 and set value items for which write-back is to be performed are selected first. After that, the identification data (ID) of the target lens body 20 is transmitted, and then a write command is transmitted. Subsequently, set values are transmitted. In the lens body 20 that has received its own identification data (ID) and the write command, set values are sequentially set. If writing is to be performed in a plurality of target lens bodies 20, this sequential process is repeated for each lens body 20. After completion of the set value write-back routine, the process returns to step S104. In step S107, a termination process is executed, and then the process proceeds to step S108, where the process is terminated.

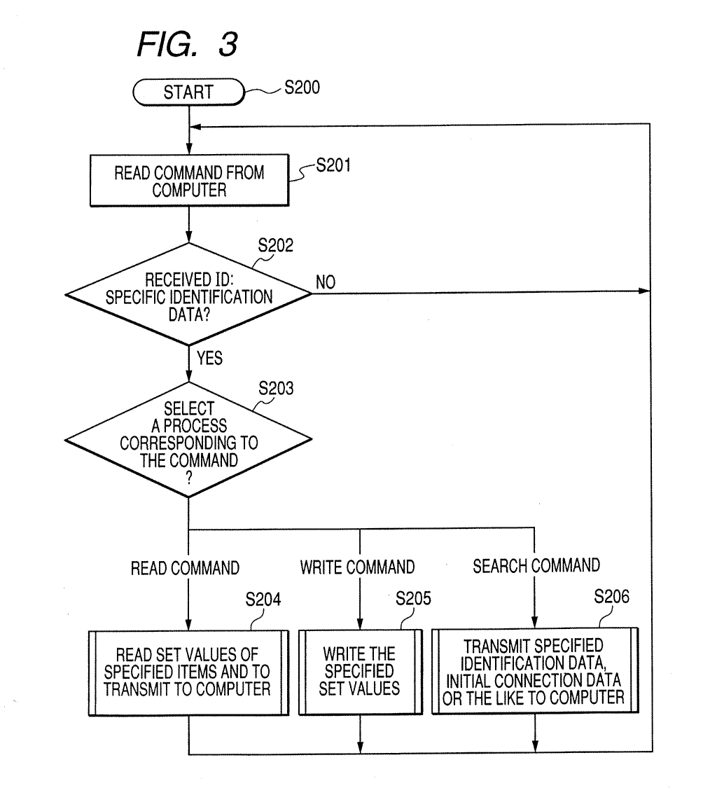

FIG. 3 is a flow chart of a process executed in the lens body 20. The process starts in step S200 and then proceeds to step S201. In step S201, identification data (ID), command and data received from the computer 40 through the wireless communication units 35, 41 are read, and then the process proceeds to step S202.

In step S202, a determination is made as to whether the received ID is identical to the camera body's own specific identification data or a comprehensive ID that designates all the lens bodies 20. If all the lens bodies 20 are designated, the process proceeds to step S203, while if not, the process returns to step S201. In step S203, the received command is identified, and the process proceeds to the corresponding routine. If the received command is a read command, the process proceeds to step S204; if the received command is a write command, the process proceeds to step S205; and if the received command is a search command, the process proceeds to step S206.

The process of step S204 is a set value read routine, where the set value(s) of a specified set item(s) is read and transmitted to the computer 40. After completion of this routine, the process returns to step S201. The process in step S205 is a set value write routine, where a specified set value(s) is written and set for a specified set item(s) by the set unit 32 in the lens body 20. After completion of the set value write routine in step S205, the process returns to step S201. The process of step S206 is a search command response routine, where specific identification data or the like is transmitted to the computer 40 in order to establish communication with the computer 40. After completion of the search command response routine in step S206, the process returns to step S201.

Table 1 shows an exemplary configuration of set values stored in the memory unit in the lens body 20. The set items are categorized broadly into zooming-lens-related items, focusing-lens-related items and stop-related items. In addition, there are other categories such as switch-related items for changing allocation of functions to switches, though items in these categories are not presented in Table 1.

The set items related to the zooming lens include parameters P1 through P7, specifically a speed parameter P1, a response parameter P2, a reproducibility parameter P3, a filter parameter P4, a gain parameter P5, an input characteristic parameter P6 and a dead band parameter P7.

TABLE 1

| | | B0 | B1 | B2 |
|---|---|---|---|---|
| | | Execution Area | Memory Area | Memory Area |
| Zooming-lens- | P1 | Speed | Speed | Speed |
| related Items | P2 | Response | Response | Response |
| | P3 | Reproducibility | Reproducibility | Reproducibility |
| | P4 | Filter | Filter | Filter |
| | P5 | Gain | Gain | Gain |
| | P6 | Input Characteristics | Input Characteristics | Input Characteristics |
| | P7 | Dead Band | Dead Band | Dead Band |
| Focusing-lens- | P8 | Speed | Speed | Speed |
| related Items | P9 | Response | Response | Response |
| | P10 | Reproducibility | Reproducibility | Reproducibility |
| | P11 | Filter | Filter | Filter |
| | P12 | Gain | Gain | Gain |
| | P13 | Input Characteristics | Input Characteristics | Input Characteristics |
| | P14 | Speed | Speed | Speed |
| Stop-related | P15 | Speed | Speed | Speed |
| Items | P16 | Response | Response | Response |
| | P17 | Reproducibility | Reproducibility | Reproducibility |

P1 (speed): an item for setting the maximum moving speed of the zooming lens from the telephoto end to the wide-angle end or from the wide-angle end to the telephoto end
P2 (response): an item for setting response on an occasion in which a stepwise input command is given
P3 (reproducibility): an item for setting stopping accuracy for a command value
P4 (filter): an item that is set when a command signal from the command unit is to be smoothed by filtering
P5: (gain): a multiplier coefficient used in generating a zooming lens drive signal a by calculation in the CPU 26
P6 (input characteristics): an item that is set when a command signal from the command unit is to be transformed into a specific command signal using a function transformation or the like
P7 (dead band): an item that is set when a dead band width of the command unit is to be changed

Besides the above, there may be provided set items like P8 to P17 in Table 1 related to drive control for movable optical members such as the focusing lens and the stop. In addition, there may be provided set items related to an extender and an optical image stabilization lens.

There is a plurality of blocks each including all the set items. In the case of Table 1, three blocks B0 to B2 are shown. Block B0 is an execution area that is actually used by the CPU 26 in controlling drive of the movable optical members. The other blocks B1, B2 are memory areas that may be overwritten into block B0 in response to a change in the shooting situation or the camera operator to change the set values of all the set items in a moment.

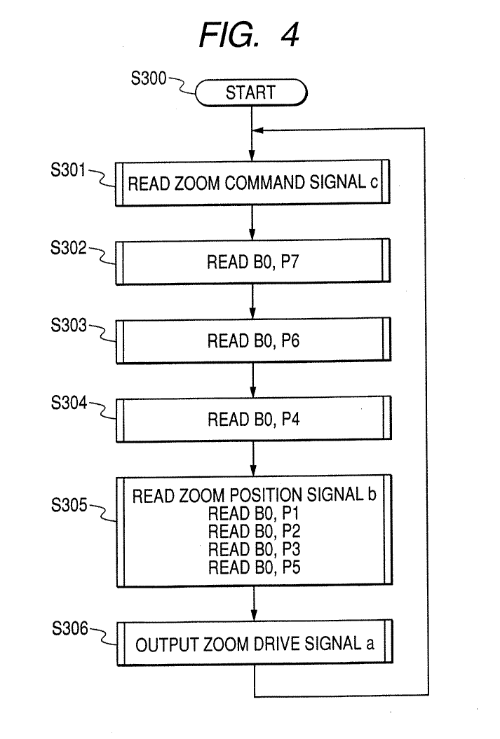

FIG. 4 is a flow chart of a process executed by the CPU 26 when driving of the zooming lens is performed in the lens body 20 having the set value configuration shown in Table 1. The process starts in step S300 and then proceeds to step S301, where a zooming lens command signal c is read. Then, the process proceeds to step S302, where a dead band process is executed.

Specifically, a dead band set value f of parameter P7 in block B0 is read, and if the absolute value of the zooming lens command signal c is smaller than the dead band set value f, the zooming lens command signal c is made equal to zero. If the absolute value of the zooming lens command signal c is larger than the dead band set value f, the zooming lens command signal c is changed to “a-f”. Then, the process proceeds to step S303, where alteration of input characteristics is performed. Specifically, an input characteristic number of parameter P6 in block B0 is read.

Let X be the input before transformation and Y be the output after transformation. In the case where the input characteristic number is 0, transformation is not performed, and Y=X accordingly. In the case where the input characteristic number is 1, Y=X². In the case where the input characteristic number is 2, Y=X³. In the case where the input characteristic number is 3, Y=1/X. In the case where the input characteristic number is 4, Y=1/X². In this way, the input characteristics are changed by using a transformation formula or table associated with the set value.

Next, the process proceeds to step S304, where filtering process is executed. Specifically, the filter set value of parameter P4 in block B0 is read, and digital filtering is performed using a filter constant associated with this filter set value to process the command value. In this way, processing on the zooming lens input command signal c can be performed according to steps S301 to S304.

Then, the process proceeds to step S305, where the zooming lens input command signal c in step S304 and the zooming lens position signal b from the potentiometer 23 are read, and calculation for generating a zooming lens drive signal a is performed. For this purpose, the speed set value of parameter P1 in block B0, the response set value of parameter P2 in block B0, the reproducibility set value of parameter P3 in block B0 and the gain set value of parameter P5 in block B0 are read in step S305. Then, calculation is performed using calculation constants associated with the respective set values to calculate the zooming lens drive signal a. After that, the process proceeds to step S306, where the zooming lens drive signal a is output, and then the process returns to step S301.

The lens body 20 can control driving of the zooming lens 21 using the set values shown in Table 1 according to the process shown in the flow chart of FIG. 4, whereby operationality and performance suitable for the shooting situation and/or preference of the camera operator can be achieved.

By the configuration shown in FIG. 1 and the processes shown in the flow chart of FIGS. 2 to 4, reading, changing and writing of various set values can be performed between the computer 40 and the lens body 20 by wireless communication without using a specific cable for exclusive use. Furthermore, a plurality of lens bodies 20 in one studio can be searched for and displayed in a list on the display unit 33, and then only the set values in each lens body 20 that are required to be changed can be changed, or set values can be rewritten into all the lens bodies 20 simultaneously in a moment. Thus, change of setting can be performed for a plurality of lens bodies 20 accurately and efficiently.

In this embodiment, at a time when various setting values are to be written into a plurality of lens bodies 20 from the computer 40, the same parameter can be written into all the lens bodies 20 simultaneously according to the target lens bodies 20 and set items. Alternatively, a specific lens body 20 may be specified and specified set items may be changed sequentially. Furthermore, the parameters can be written either in such a way that the same parameters related to each movable optical member (such as zooming, focusing, iris, extender or IS optical member) are written in all the lens bodies simultaneously or in such a way that different parameters are written in different lens bodies. These ways of writing may be selected suitably by the camera operator, or alternatively the way of writing may be selected automatically in accordance with the shooting situation.

By the above features, for example in terms of the items related to the stop that is required to have the same characteristics among the lens bodies 20 in one studio, writing of the same set values can be commanded for all the lens bodies 20. On the other hand, in terms of the items related to the zooming lens and the focusing lens that are required to have characteristics that are different among camera operators, the set values can be changed for each individual lens body 20. For example, a camera operator may input information on the camera operator (drive control parameter) into a lens body, whereby the information is transmitted to the computer wirelessly, so that the computer that has received the information will command the lens body wirelessly to change setting. In addition, by using the simultaneous writing and the sequential writing selectively for each of the above described related items, setting can be performed in a desired manner in a short time.

In this embodiment, various set values may be read into the computer 40 from each lens body 20 and stored in the memory unit (memory circuit or the like) in the computer 40 together with the specific lens identification data. By doing so, set values of the lens bodies in one studio can be managed collectively. Changing of data on the computer 40 may be performed not only by using a keyboard or mouse but also by reading a setting file prepared in advance or performed by another computer through the Internet. In these cases also, the same advantages can be achieved.

A second lens body that is not shown in the drawings may be substituted for the computer 40 shown in FIG. 1. The second lens body may have the same configuration as the lens body 20 shown in FIG. 1. The display unit of the second lens body corresponds to the display of the computer 40, and the command unit of the second lens body corresponds to the keyboard of the computer 40. By setting the lens body appropriately, it can have functions equivalent to those of the computer.

This enables the second lens body and a plurality of lens bodies 20 to be connected by wireless communication units. Furthermore, by using the display unit and the command unit of the second lens body, the processes that have been described in connection with the above described embodiment can be performed in a similar manner as well as processes such as displaying, editing and rewriting of the set value information that the plurality of lens bodies 20 have.

In this case, an extra device such as a computer 40 is not needed, and the processes can be performed using a plurality of lens bodies 20 in the studio, whereby improvement in convenience can be achieved in addition to the advantages achieved by the embodiment.

According to the lens system (lens apparatus) according to this embodiment, a lens apparatus and an external device can be connected by wireless communication units without using a specific cable for exclusive use, and set values in the lens apparatus can be changed by operating the external apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-158336, filed Jun. 15, 2007, which is hereby incorporated by reference herein in its entirety.

What is claimed is:

1. A lens system comprising:
a first lens apparatus including a first movable optical member; and
a first set command unit that changes a drive control parameter for the first movable optical member by performing wireless communication with the first lens apparatus.

2. A lens system according to claim 1, further comprising a second set command unit that changes the drive control parameter for the first movable optical member, the second set command unit being configured to be fixed to the first lens apparatus or connected with the first lens apparatus through a cable.

3. A lens system according to claim 1, wherein the first set command unit searches for another lens apparatus existing in a wirelessly-communicable area, and sets a drive control parameter for a movable optical member that the another lens apparatus has based on a result of the search.

4. A lens system according to claim 1 further comprising a second lens apparatus including a second movable optical member, said first lens apparatus having first identification data that is specific to the first lens apparatus and the second lens apparatus having second identification data that is specific to the second lens apparatus,
wherein the first set command unit changes the drive control parameter for the first movable optical member for the first lens apparatus after receiving the first identification data and changes a drive control parameter for the second movable optical member for the second lens apparatus after receiving the second identification data.

5. A lens system according to claim 1, wherein the first lens apparatus has a first identification data that is specific to the first lens apparatus, and the first set command unit is provided with a memory unit that stores the drive control parameter for the first movable optical member in association with the first identification data.

6. A lens system according to claim 1, further comprising a second lens apparatus including a second movable optical member,
wherein the first set command unit has a mode in which rewriting of the same drive control parameter is performed simultaneously for both the first and second lens apparatuses by wireless communication and a mode in which rewriting of the drive control parameter is performed sequentially for the first and second lens apparatuses.

7. A lens system according to claim 1, further comprising a second lens apparatus,
wherein the first set command unit is configured to be fixed to the second lens apparatus or connected with the second lens apparatus through a cable.

8. A lens apparatus, comprising:
a first movable optical member which moves; and
a set command unit that changes a drive control parameter for the first movable optical member,
wherein the set command unit wirelessly communicates with a second lens apparatus having a second movable optical member, thereby changing a drive control parameter for the second movable optical member.

9. A lens apparatus according to claim 8, further comprising a drive unit that drives the first movable optical member,
wherein the set command unit and the drive unit are connected to each other by wire.

10. A lens apparatus, comprising:
a first movable optical member which moves; and
a wireless communication unit which wirelessly communicates with external devices,
wherein the lens apparatus changes a drive control parameter for the first movable optical member based on data received by the wireless communication unit.
